(19) United States
(12) Patent Application Publication
(10) Pub. No.: US 2014/0129609 A1
(43) Pub. Date: May 8, 2014

(54) Computation of Componentized Tasks Based on Availability of Data for the Tasks

(71) Applicant: Rational Systems LLC, Houston, TX (US)

(72) Inventor: Nicholas Mark Goodman, San Mateo, CA (US)

(73) Assignee: Rational Systems LLC, Houston, TX (US)

(21) Appl. No.: 14/071,645

(22) Filed: Nov. 5, 2013

Related U.S. Application Data
(60) Provisional application No. 61/722,606, filed on Nov. 5, 2012.
(60) Provisional application No. 61/722,585, filed on Nov. 5, 2012.
(60) Provisional application No. 61/722,615, filed on Nov. 5, 2012.

(51) Int. Cl. H04L 29/08

(52) U.S. Cl. CPC H04L 67/10
USPC 709/201

(57) ABSTRACT

A base computer system obtains a set of definitions of calculations to be performed, and periodically monitors a data store to see if the data required for the calculations are available. When the required data for a given calculation are available, the base computer system sends the data and calculation instructions to a group of one or more remote computer systems for execution. The remote computer systems may be equipped with Graphics Processing Units (GPUs) for high-performance computation. The base computer system then awaits the return of reports from the one or more remote computer systems.

This application claims the benefit of the following commonly-owned co-pending provisional applications: Ser. No. 61/722,585, “Offloading of CPU Execution”; Ser. No. 61/722,606, “Parallel Execution Framework”; and Ser. No. 61/722,615, “Lattice Computing”; with the inventor of each being Nicholas M. Goodman, and all filed Nov. 5, 2012.

This application is one of three commonly-owned non-provisional applications being filed simultaneously, each claiming the benefit of the above-referenced provisional applications, with the inventor of each being Nicholas M. Goodman. The specification and drawings of each of the other two non-provisional applications are incorporated by reference into this specification. One of them, entitled “Parallel Execution Framework,” is cited in places below.

### BACKGROUND OF THE INVENTION

This invention relates to an improved method for performing large numbers of computations involving a great deal of data. See the Background section of the Parallel Execution Framework application for additional discussion.

### SUMMARY OF THE INVENTION

A base computer system obtains a set of definitions of calculations to be performed, and periodically monitors a data store to see if the data required for the calculations are available. When the required data for a given calculation are available, the base computer system sends the data and calculation instructions to a group of one or more remote computer systems, referred to as “task servers,” for execution. The task servers may be equipped with Graphics Processing Units (GPUs) for high-performance computation. The base computer system then awaits the return of reports from the one or more task servers.

### BRIEF DESCRIPTION OF THE DRAWINGS

FIG. 1 is a simplified diagram of a base computer system connected to one or more task servers in accordance with the invention.

### DETAILED DESCRIPTION OF SPECIFIC EMBODIMENTS

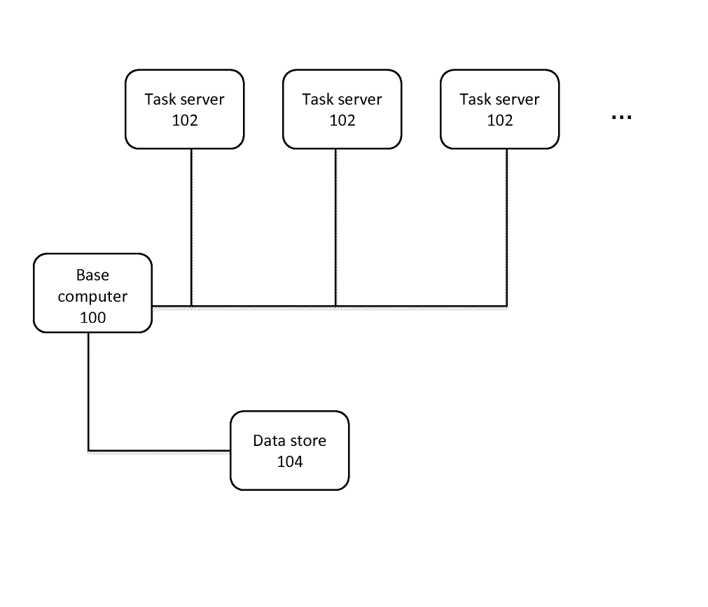

Referring to FIG. 1, a base computer system 100 communicates with a database system 104, which could be implemented as part of the base computer system 100 or as part of a separate server-type system. The base computer system also communicates with a plurality of remote computer systems, referred to as “task servers” 102. See the Parallel Execution Framework application for additional discussion of the computer-related hardware used in connection with the invention. (In that application, the base computer system 100 is referred to as the scheduler 100 because of the functions it performs in that context.)

The base computer system 100 obtains a set of definitions of calculations to be performed. This is described in more detail in the Parallel Execution Framework application.

An illustrative method in accordance with the invention can be conveniently described with a simplified example. Suppose that a power company needs to produce bills for each of its 100,000 customers. Suppose also that each customer has at least one “smart” meter, and—significantly—that some business customers have multiple meters.

The power company might input a definition of the business algorithm, that is, the computational work, of generating customers' monthly power bills. In greatly simplified form, that algorithm might consist of adding up the products of (i) each relevant customer's power usage at given times, multiplied by (ii) the spot (market) rates for power at the relevant times, where power-usage computation is made by subtracting a previous meter reading from the then-current meter reading.

The algorithm might be stated in equation form as the sum of various component calculations, or subtasks. For example: Total Billed Amount=Billed Amount for Meter 1+Billed Amount for Meter 2+. . . . In turn, the Billed Amount for, say, Meter X can be broken down into the following: Billed Amount for Meter X=(Meter X Power Usage 1×Spot Rate 1)+(Meter X Power Usage 2×Spot Rate 2)+. . . . Finally each Power Usage calculation for Meter X can be broken down still further into, for example, Power Usage 14=(Meter X Reading 14−Meter 1 Reading 13). Each of these component calculations might constitute a work unit as a part of the larger work of calculating the Total Billed Amount.

Note that the business algorithm for computing the Total Billed Amount has a predetermined stopping condition, namely that the execution of the algorithm ceases when all of the component calculations have been done and the Total Billing Amount has been computed.

It will be apparent that the computation of the Total Billed Amount for a given customer is dependent on the computation of the individual meters' Billed Amount numbers. One approach to managing these and similar dependencies is described in the Parallel Execution Framework application.

Because of the nature of the overall computation (in this example, a simple summation of component calculations), it can be done piecemeal as the required data become available, which in the simplified example above would be power-meter readings and spot prices. Accordingly, the base computer system 100 proactively monitors the data store 104, in a conventional manner, by running an application that “wakes up” every so often (e.g., every minute or two) and checks the status of various data records in the data store.

Returning to the example: Suppose that the base computer system 100 recognizes that power-meter readings for certain power meters are available for the period 3 PM to 9 PM, and that spot prices are available for the period from 2 PM to 7 PM. The base computer system 100 therefore determines that the bill for the period of overlap, from 3 PM to 7 PM, can be computed.

The base computer then transmits, to each of one or more of the task servers, a work order comprising a set of one or more designated instructions and related data elements. In our example, the base computer system 100 transmits the measurements and prices for 3 PM to 7 PM to one or more of the task servers 102.

It should be apparent to one of ordinary skill having the benefit of this disclosure that a smart implementation would involve remote caching (perhaps an attribute with a data set would be how long to cache it). This would allow the base computer system 100 to transmit the spot prices, which in this example are used for many customers, one time, greatly reducing the overall communication cost.

The task servers 102 divide the work among themselves and execute it. The division of work among the task servers occurs conventionally based upon the type of instruction, the data, and the hardware available. For example, given a dense BLAS operation, the task servers might divide the work equally among any nodes with Graphics Processing Units (GPUs). It often makes sense to divide work based upon the performance of the hardware available; if the hardware is all roughly equivalent, then equal division of work is often an acceptable method. If the time per unit of work varies heavily, then work queues or parent-child relationship methods may be appropriate.

The task servers perform the designated computations and produce one or more “answers” or partial answers. In doing so, they execute CPU instructions to perform the desired computation to the desired level of accuracy. For example, one implementation might utilize the PETSc, LAPACK, ScaLAPACK, and/or CUDA libraries on a cluster of computers to perform the matrix-vector multiplication needed to compute the bills desired by the power company in our example.

One or more of the task servers transmit one or more completion messages to the base computers; each completion message is comprised of a status indicator and zero or more results. In our example of power billing, the base computer system can then combine the results into a single bill.

Given the restriction on operations, it may well make sense for the task servers 102 to have significant amounts of GPU power; as is well known, the use of GPUs is currently one of the most cost-effective approaches to executing such linear algebra operations.

It should be apparent to one of ordinary skill what the BLAS operations are and that there are many effective BLAS libraries such as, for example, LAPACK.

### Programming; Program Storage Device

The system and method described may be implemented by programming suitable general-purpose computers to function as the various server- and client machines shown in the drawing figures and described above. The programming may be accomplished through the use of one or more program storage devices readable by the relevant computer, either locally or remotely, where each program storage device encodes all or a portion of a program of instructions executable by the computer for performing the operations described above. The specific programming is conventional and can be readily implemented by those of ordinary skill having the benefit of this disclosure. A program storage device may take the form of, e.g., a hard disk drive, a flash drive, another network server (possibly accessible via Internet download), or other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here.

### Alternatives

The above description of specific embodiments is not intended to limit the claims below. Those of ordinary skill having the benefit of this disclosure will recognize that modifications and variations are possible; for example, some of the specific actions described above might be capable of being performed in a different order.

I claim:

1. A method, executed by a base computer system, of causing the execution of a series of potentially-dependent calculations, comprising the following:
(a) The base computer obtains, from a data store, a set of one or more definitions, each definition specifying one of said calculations;
(b) One of more of the defined calculations requires one or more data inputs;
(c) The base computer monitors a data store for the presence of the required data inputs; and
(d) As all required data inputs for a specified calculation become available in the data store, the base computer transmits, to each of one or more remote computer systems, referred to as “task servers,” a set of one or more instructions and the required data inputs for performing the specified calculation.

3. A program storage device readable by a base computer system, containing a machine-readable description of instructions for the base computer system to perform the operations described in claim 1.

4. A program storage device readable by a base computer system, containing a machine-readable description of instructions for the base computer system to perform the operations described in claim 2.
